(19) United States
(12) Patent Application Publication
(10) Pub. No.: US 2016/0019815 A1
(43) Pub. Date: Jan. 21, 2016

(54) SYSTEM AND METHOD FOR INSTRUCTIONAL SYSTEM DESIGN USING GAMING AND SIMULATION

(71) Applicant: DEE GEE HOLDINGS, LLC, Cape Canaveral, FL (US)

(72) Inventors: TIMOTHY HAGERTY, Cocoa Beach, FL (US); David Figley, Yorktown, VA (US); Ron Offutt, New Albany, IN (US)

(73) Assignee: DEE GEE HOLDINGS, LLC, Cape Canaveral, FL (US)

(21) Appl. No.: 14/801,097

(22) Filed: Jul. 16, 2015

Related U.S. Application Data
(60) Provisional application No. 62/025,270, filed on Jul. 16, 2014.

(51) Int. Cl. G09B 19/00; G09B 5/08

(52) U.S. Cl. CPC G09B 19/0053; G09B 5/08

(57) ABSTRACT

Computer-implemented systems and methods for generating executable code for a simulation-based courseware program are provided. The system may comprise a courseware server having a processor, a database, a compiler, an analysis subsystem, a design subsystem, a development subsystem, an implementation subsystem, an evaluation subsystem, and/or an access control system. Each of the subsystems may facilitate manipulation of information in the database by training developers (e.g., subject matter experts, information system designers, and/or media technicians) to generate a simulation-based courseware program for execution by and evaluation of trainees.

### RELATED APPLICATIONS

This application claims the benefit under 35 U.S.C. §119(e) of U.S. Provisional Patent Application Ser. No. 62/025,270 (Attorney Docket No. 89.00031) filed on Jul. 16, 2014 and titled SYSTEM AND METHOD FOR INSTRUCTIONAL SYSTEM DESIGN USING GAMING AND SIMULATION, the entire content of which is incorporated herein by reference.

### FIELD OF THE INVENTION

The present invention relates to the field of automated training development and, more specifically, to computer-implemented systems and methods for analysis, design, development, implementation, and evaluation of automated courseware.

### BACKGROUND OF THE INVENTION

The use of instructional technology to support learning was born as a response by the United States military to the problems of a labor shortage experienced during World War II. With the coming of the Information Age, many of the advancements in computing and networking technology were applied to the theory and practice of creation, utilization, management, and assessment of processes and resources for learning. Today, both government and corporate training entities seek to employ rapidly evolving instructional technologies to more efficiently and effectively engage learners. One such technology is automated instructional systems, also known as “courseware.”

Courseware design has progressed from simple text-based implementations to complex interactive multi-media environments that may comprise a range of “assets” (defined as information content represented in any computer-readable form, including text, image, audio, and video). Creation of such courseware typically requires contributions from stakeholders drawn from multiple specialties. For example, implementation of even the simplest, text-based instructional tools typically involves both subject matter experts, who provide educational requirements and topical content, and instructional designers, who develop course deliverables and evaluation methods. Courseware that incorporates more complex assets such as audio and video often requires contributions from media technicians who are uniquely skilled in creating such assets.

Coordinating the widely diverse work processes of subject matter experts, instructional designers, and media technicians to collaboratively develop and improve a courseware application is often hindered by the specialized nature of each participant's contribution. For example, to capture educational content and training objectives, the subject matter expert may apply context and use tools unique to a field of endeavor that is to be the subject of the desired training, but that is unfamiliar to the instructional designer. The instructional designer may, in turn, use tools unique to the courseware development trade to analyze the furnished requirements information and training objectives to develop a design plan. Design planning may, for example, involve developing a storyboard of each lesson and conducting requirement reviews with the subject matter expert to confirm understanding on the part of the designer. Lastly, one or more media technicians may use tools unique to asset creation to develop planned learning objects and/or to integrate externally developed learning objects into the courseware solution. Asset development phases may require reviews with the instructional designer and/or the subject matter expert to confirm the successful incorporation of assets into the desired courseware. Such specialization of creation activities, tools, and participants (sometimes referred to as “stovepiping”) often results in an expensive, time-consuming check and re-check process that may bottleneck at the media technician who typically is the only resource capable of creating and/or modifying the complex assets desired in modern courseware.

A new class of complex assets that hold promise for courseware development come from the field of gaming and simulation. Gaming and simulation refers to assignment of behavior to assets and presentation of those assets to a user of a gaming and simulation computer system. The user may interact with the courseware by manipulating the behaviors of the assets within the parameters of the presentation. For example, when a user is presented with specific visual and audio cues, the user may move a computer mouse, activate a joystick, or otherwise interact with the computer system to effect the presentation of the simulated environment. The reaction of the user to the presentation of the audio and/or visual information affects subsequent presentation. In this way, training simulation may present to the learner a virtual medium through which various types of skills may be acquired.

Unfortunately, introduction of gaming and simulation technology to courseware development may exacerbate the stovepiping problem described above. More specifically, the lack of a seamless, cross-specialty Instructional Systems Design (ISD) environment to discipline the complicated and detailed specification and implementation of simulation-based courseware may add substantial costs in terms of the time and effort required to create and enhance such courseware. Currently, existing instructional methodologies do not adequately address how to design and deliver learning in the context of gaming and simulation as an alternative to or in combination with traditional technologies within an instructional environment. Providing an integrated and feature-rich courseware development toolkit that facilitates orderly collaboration among such diverse creation contributors has been the subject of research in the art.

U.S. patent application Ser. No. 11/216,377 by Kirkley et al. discloses a system and method that facilitates authoring and iterative development of mixed reality and video game environments in a manner generally consistent with a disciplined model for ISD. However, the Kirkley authoring tool is designed to primarily support analysis and design processes, while leaving the production of the materials and runtime delivery to be accomplished using other tools.

PCT Patent Application No. PCT/US00/28762 by Zwart discloses an ISD-based system used to create, edit, deliver, maintain, and manage complex training and knowledge management systems. The disclosed implementation incorporates dynamic learning objects to reduce the cost of developing, publishing, and revising training content. However, the Zwart disclosure does not include methods or systems tailored for the unique challenges of manipulating gaming and simulation assets.

U.S. patent application Ser. No. 12/002,559 by Gradisar et al. discloses an interactive multimedia instructional program that allows inexperienced developers to create learning programs using a base graphics system pre-programmed to include instructional templates (including, for example, graphics and video). However the graphic authoring tools used in the disclosed implementation do not accommodate gaming and simulation technology.

European Patent No. EP 1 895 487 A2 by Ahl et al. discloses systems and methods for development of a training course based on operational and/or training electronic media selected from a repository of such media. The electronic media may include objects such as photographs, videos, and/or three-dimensional animations. However, like the Gradisar disclosure, the Ahl disclosure does not describe an implementation that accommodates gaming and simulation.

A need exists for automated support for training courseware development that employs gaming and simulation assets artifacts. More specifically, a courseware development environment is required that would allow ISDs to directly enter and manipulate instructional materials and questions with little or no dependence on media technician to effectively employ gaming and simulation assets.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the above in mind, embodiments of the present invention are directed to systems and methods for using gaming and simulation in automated training development and delivery. The present invention may be configured to facilitate cost-effective and time-efficient analysis, design, development, implementation, and evaluation (ADDIE) of courseware. The present invention may be configured to incorporate into such courseware high levels of interaction through use of gaming and simulation assets that may advantageously enhance the instructional experience and knowledge retention of a trainee.

The present invention may be configured to be deployable across a network on an ISD-friendly platform, and to advantageously facilitate export of training materials to multiple platforms and operating systems. The present invention may feature an interface designed for use during all ADDIE phases by an instructional system designer, so as to advantageously minimize dependence on subject matter experts and/or media technicians to accomplish courseware creation and maintenance. The present invention may be configured to feature documented procedures, team development characterized by specialization, content distinguished from strategy, and feedback-based continuous improvement to advantageously facilitate training evaluation and courseware maintenance. The present invention may be configured to advantageously allow creation, distribution, and maintenance of courseware while advantageously overcoming challenges related to networthiness, content security, and iterative development.

The simulation-based instructional system design (SISD) system according to embodiments of the present invention may be configured as a computer program product that may include a data store, a processor, and a network interface. Data and/or instructions may be recorded to the data store. The processor may operate upon the data and/or instructions recorded in the data store, and may employ the network interface to communicate across a network with other devices in a client-server configuration. The data store may include information content that may be used to populate simulation-based courseware. Further, the data store may be user-searchable, and the assets may be user-selectable. The SISD system may be in data communication with networked servers configured for creation of assets for games and simulations. The SISD system may include an analysis subsystem, a design subsystem, a development subsystem, an implementation subsystem, an evaluation subsystem, and an access control subsystem. The SISD system may include a training developer client in data communication with a courseware server that may host the analysis, design, development, implementation, evaluation, and access control subsystems. The training developer client may present one or more system interfaces configured to allow use of the SISD system by users in courseware creation roles, including subject matter experts, information system designers, and media technicians. The SISD system may include a trainee client in data communication with the courseware server. The trainee client may present at least one system interface configured to allow use of the SISD system by users courseware viewing and evaluation roles, including trainees.

More specifically, the SISD may comprise a computer program product for generating executable code for a simulation-based courseware program. The computer program product may comprise a courseware server that may include a processor, a database, a compiler, and a plurality of subsystems. The subsystems may include an analysis subsystem, a design subsystem, a development subsystem, an implementation subsystem, an evaluation subsystem, and/or an access control system. Each of the plurality of subsystems may include a respective interface to manipulate information included in the database.

The analysis subsystem may receive a project definition and a training object. The design subsystem may receive an instructional strategy, a course activity, and a course content. The development subsystem may receive a plurality of assets, at least one of which may be a simulation asset, and other assets that may include one or more of text, image, audio, and video assets. The database may be used to store the project definition, the training objective, the instructional strategy, the course activity, the course content, and the plurality of assets. The implementation subsystem is configured to generate the simulation-based courseware program using the information in the database. More specifically, the implementation subsystem may operate the compiler to create the executable computer code for the simulation-based courseware program. The evaluation subsystem may receive an indicator of training completion, and/or may execute at least one of a pre-test evaluation and a post-test evaluation.

The access control subsystem may receive a computer program product access request, may match the computer program product access request to a training developer registration stored in the database, and may operate at least one of the plurality of subsystems to include enforcing role-based permissions associated with the trainer registration. The role-based permissions may include a subject matter expert role, an information system designer role, and a media technician role. The access control system also may receive a courseware program access request, may match the courseware program access request to a trainee registration stored in the database, and may enforce role-based permissions associated with the trainee registration (e.g., a trainee role).

The computer program product may further comprise a training developer client in data communication with the courseware server via a network. The training developer client may create and transmit to the courseware server the project definition, the training objective, the instructional strategy, the course activity, the course content, and/or the plurality of assets. The computer program product may further comprise a trainee client in data communication with the courseware server via a network. The trainee client may operate the simulation-based courseware program to display the simulation asset, to receive trainee input, and to manipulate a behavior of the simulated asset based on the trainee input. The simulation asset may be an avatar, a scene, or a prop. The behavior of the simulation asset may be a movement, a sound, or an environment.

### BRIEF DESCRIPTION OF THE DRAWINGS

FIG. 1 is a schematic block diagram of a Simulation-based Instructional Systems Design (SISD) system according to an embodiment of the present invention.

FIG. 2 is a diagram illustrating exemplary data structures of the SISD system depicted in FIG. 1.

FIG. 3 is a flow chart illustrating a method for creating and maintaining courseware as used in connection with a SISD system according to an embodiment of the present invention.

FIG. 4 is a flow chart illustrating a method of creating a user account as used in connection with a SISD system according to an embodiment of the present invention.

FIG. 5 is a diagram illustrating an exemplary system interface for defining projects as part of analyzing training requirements as used in connection with a SISD system according to an embodiment of the present invention.

FIG. 6 is a diagram illustrating an exemplary system interface for defining learning objectives as part of analyzing training requirements as used in connection with a SISD system according to an embodiment of the present invention.

FIG. 7 is a diagram illustrating an exemplary system interface for structuring lessons as part of courseware design as used in connection with a SISD system according to an embodiment of the present invention.

FIG. 8 is a diagram illustrating an exemplary system interface for lesson content creation as part of courseware development as used in connection with a SISD system according to an embodiment of the present invention.

FIG. 9 is a diagram illustrating an exemplary system interface for media element creation as part of courseware development as used in connection with a SISD system according to an embodiment of the present invention.

FIG. 10 is a diagram illustrating an exemplary system interface for learning check creation as part of courseware development as used in connection with a SISD system according to an embodiment of the present invention.

FIG. 11 is a diagram illustrating an exemplary system interface for courseware implementation as used in connection with a SISD system according to an embodiment of the present invention.

FIG. 12 is a block diagram representation of a machine in the example form of a computer system according to an embodiment of the present invention.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

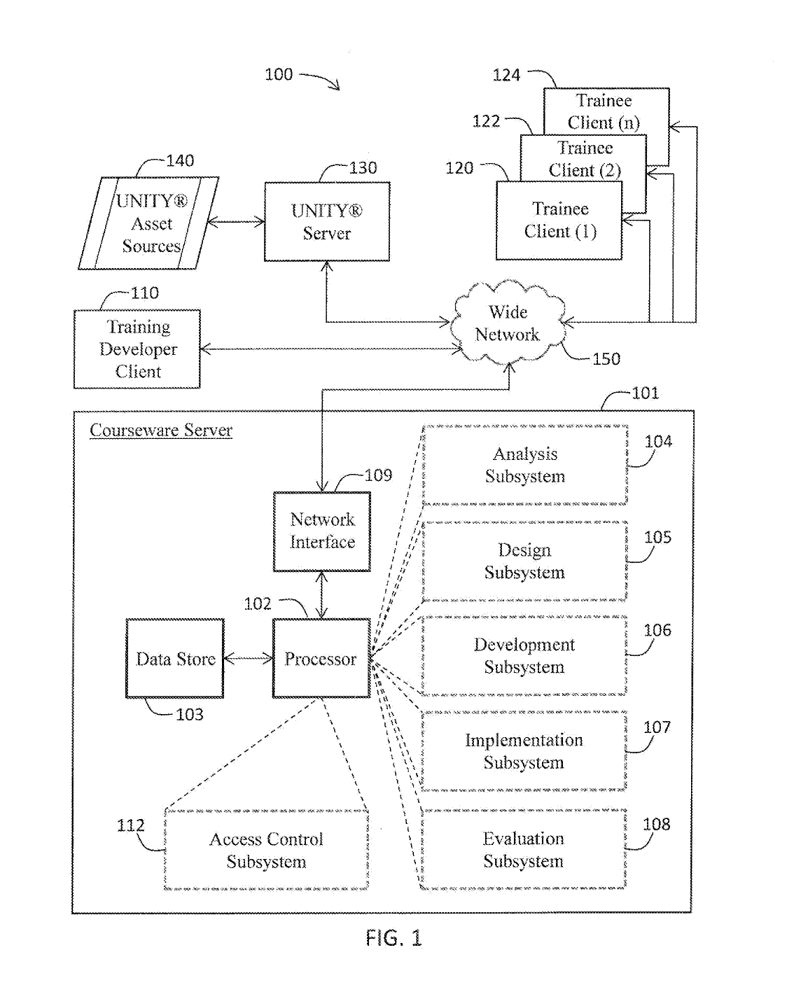

Referring to FIGS. 1-12, a simulation-based instructional system design (SISD) system according to an embodiment of the present invention is now described in detail. Throughout this disclosure, the present invention may be referred to as an instructional systems design (ISD) system, a training design system, an automated design system, a computer-based training development system, a design system, a development system, a computer program product, a computer program, a product, a system, a device, and a method. Furthermore, the present invention may be referred to as relating to application of gaming and simulation to the implementation of training solutions. Those skilled in the art will appreciate that this terminology does not affect the scope of the invention. For instance, the present invention may just as easily relate to the implementation of education systems, expert systems, and behavior modeling systems.

Example methods and systems for a simulation-based instructional systems design (ISD) system are described herein below. In the following description, for purposes of explanation, numerous specific details are set forth to provide a thorough understanding of example embodiments. It will be evident, however, to one of ordinary skill in the art that the present invention may be practiced without these specific details and/or with different combinations of the details than are given here. Thus, specific embodiments are given for the purpose of simplified explanation and not limitation. Some of the illustrative aspects of the present invention may be advantageous in solving the problems herein described and other problems not discussed which are discoverable by a skilled artisan.

Referring now to FIG. 1, the SISD system 100 according to an embodiment of the present invention will now be discussed in greater detail. An embodiment of the invention, as shown and described by the various figures and accompanying text, provides an SISD system 100 that may implement an automated method of analyzing, designing, developing, implementing, and evaluating automated courseware. For example, and without limitation, the SISD system 100, according to an embodiment of the present invention, may include a Courseware Server 101, which may be in data communication with a Training Developer Client 110, a Trainee Client 120, and a gaming and simulation asset server 130. For example, and without limitation, the gaming and simulation asset server may be a third-party server such as a UNITY® Server 130. The Training Developer Client 110, Trainee Client 120, and UNITY® Server 130 each may be coupled to the Courseware Server 101 using a wide area network 150 such as the Internet. The Courseware Server 101 also may have access to various third-party simulation and gaming asset sources 140 through the simulation and gaming server 130 and/or through the Internet 150 directly.

For example, and without limitation, the Training Developer Client 110 may comprise a web browser and a communication application. “Web browser” as used herein includes, but is not limited to, any application software or program (including mobile applications) designed to enable users to access online resources and conduct trusted transactions over a wide network such as the Internet. “Communication” as used herein includes, but is not limited to, electronic mail (email), instant messaging, mobile applications, personal digital assistant (PDA), a pager, a fax, a cellular telephone, a conventional telephone, television, video telephone conferencing display, other types of radio wave transmitter/transponders and other forms of electronic communication. For example, and without limitation, the Training Developer Client 110 and Trainee Client 120 may be configured to execute web applications designed to function on any cross-platform web server running Apache, MySQL, and PHP. Those skilled in the art will recognize that other forms of communication known in the art are within the spirit and scope of the present invention.

A typical user of a Training Developer Client 110 may be a contributor to the process of creating and deploying courseware. Such a user may interact with various servers included in the SISD System 100 through the Training Developer Client 110. For example, and without limitation, SISD System 100 users may include subject matter experts in a field of interest. Such subject matter experts may use the Training Developer Client 110 to express and capture training requirements in the field that is the subject of desired training. Such requirements collection may involve consideration of the expertise to be conveyed, the proficiency level of the training audience, and the trainee proficiency to be achieved. Also for example, and without limitation, SISD System 100 users may include instructional designers tasked with structuring, creating, and deploying training tools that may include gaming and simulation environments.

Continuing to refer to FIG. 1, the Courseware Server 101 may comprise a processor 102 that may accept and execute computerized instructions, and also a data store 103 which may store data and instructions used by the processor 102. More specifically, the processor 102 may be configured in data communication with a Training Developer Client 110, some number of Trainee Clients 120, 122, 124, a simulation and gaming server 130, and third-party simulation asset sources 140. The processor 102 may be configured to direct input from other components of the SISD system 100 to the data store 103 for storage and subsequent retrieval. For example, and without limitation, the processor 102 may be in data communication with external computing resources 110, 120, 122, 124, 130, 140 through a direct connection and/or through a network connection 150 facilitated by a network interface 109. Analysis Subsystem 104 instructions, Design Subsystem 106 instructions, Development Subsystem 106 instructions, Implementation Subsystem 107 instructions, Evaluation Subsystem 108 instructions, and Access Control Subsystem 112 instructions may be stored in the data store 103 and retrieved by the processor 102 for execution. Although the data store 103 of FIG. 1 is shown as local storage, a skilled artisan will recognize that the data store 103 may alternatively, or in addition, comprise one or both of server-based storage and cloud storage.

The Analysis Subsystem 104, according to embodiments of the present invention, may be configured to advantageously receive and record the overall goals of a training project and the learning needs for each project (i.e., knowledge or performance “gaps” in existing versus desired trainee behaviors). The Analysis Subsystem 104 may also advantageously record identification of the target audience for training, as well as the targeted delivery environment.

The Design Subsystem 105, according to embodiments of the present invention, may be configured to advantageously facilitate identification of learning objectives that, if achieved, would support the project goals. The Design Subsystem 105 may also advantageously capture solution models that guide development of assessment instruments (i.e., pre-tests, post-tests, evaluations), and creation of practice exercises. The Design Subsystem 105 may also be used to advantageously outline content and instructional strategies to match learning objectives.

The Development Subsystem 106, according to embodiments of the present invention, may be configured to advantageously facilitate creation of traditional and simulation-based assets for an educational program or activity (i.e., lecture slides, graphics, animations, video, audio, photographs, text, web-based tools, etc.).

The Implementation Subsystem 107, according to embodiments of the present invention, may be configured to advantageously deliver or distribute the educational program or activity to an intended audience. The Implementation Subsystem 107 may include mechanisms for advantageous intra-delivery learner support.

The Evaluation Subsystem 108, according to embodiments of the present invention, may be configured to advantageously measure the degree to which the intended learning goals or objectives are being met through the instructional design process. The Evaluation Subsystem 108 may also advantageously facilitate assessment of whether the learning needs are being satisfied in terms of the “overall effectiveness” of the educational program or activity. The Evaluation Subsystem 108 may also advantageously record changes in organizational behavior and/or outcomes based on the delivered training.

The Access Control Subsystem 112, according to embodiments of the present invention, may be configured to advantageously enforce role-based access to data and functions related to instructional systems design.

Exemplary operations of the Access Control Subsystem 112, the Analysis Subsystem 104, the Design Subsystem 105, the Development Subsystem 106, the Implementation Subsystem 107, and the Evaluation Subsystem 108 are described individually in greater detail below. Those skilled in the art will appreciate, however, that the present invention contemplates the use of computer instructions that may perform any or all of the operations involved in instructional systems design, including digital data management, version control, content searching, trainee records administration, and gap analysis. The disclosure of computer instructions that include Analysis Subsystem 104 instructions, Design Subsystem 106 instructions, Development Subsystem 106 instructions, Implementation Subsystem 107 instructions, Evaluation Subsystem 108 instructions, and Access Control Subsystem 112 instructions is not meant to be limiting in any way. Those skilled in the art will readily appreciate that stored computer instructions may be configured in any way while still accomplishing the many goals, features and advantages according to the present invention.

The Courseware Server 101 also may be in data communication with third-party software applications designed to create simulated worlds for both single-participant and multi-participant use. For example, and without limitation, the SISD system 100 may provide the capability to create training courseware using a simulation and gaming server 130 configured to execute UNITY®, which is a proprietary simulation development and delivery environment that allows users to create both games and simulations that can be delivered on the web. For example, and without limitation, the UNITY® Server 130 may comprise a web host configured for cloud computing.

UNITY® provides the software and tools to create gaming and simulation environments and characters. Users may create assets (e.g., landscapes, moon craters, figures, avatars, guns rocket knives) that may be used in the environment using third-party tools. Users may import these assets into UNITY® and then use UNITY® to give the assets their behaviors. Upon execution, UNITY® may create a runtime package that may be executed within a web-browser to display simulation assets exhibiting their assigned behaviors and relationships. UNITY® may support an APP store that may provide a user access to assets created by other UNITY® users. To address the unique challenges of development of software applications for use by government entities, including the United States military, UNITY® is available in a government-approved plug-in (Gold standard configuration). This means that UNITY® based simulations may be executed securely on government computers and digital training facilities.

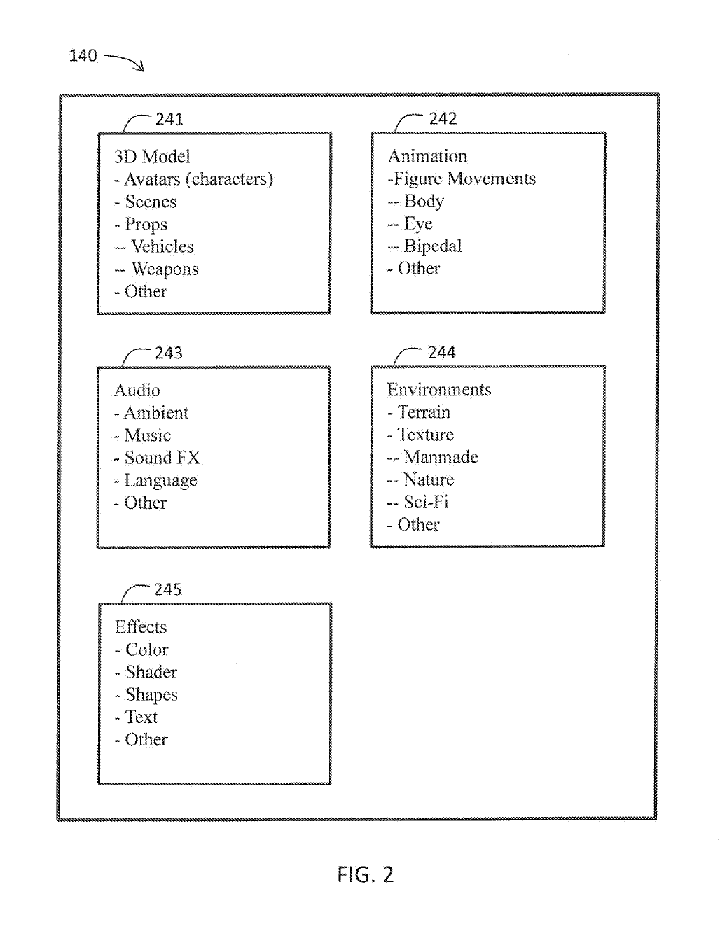

Continuing to refer to FIG. 1, and referring additionally to FIG. 2, the Courseware Server 101 may retrieve gaming and simulation assets, and may write to the data store 103 the digital content files representing those assets. For example, and without limitation, the UNITY® server 130 may process a request from one or more of the subsystems 104, 105, 106, 107, 108, 112 of the SISD system 100 to download a copy of a particular gaming and simulation asset from available UNITY® Asset Sources 140. The embodiment of third-party gaming and simulation asset sources 140 illustrated in FIG. 2 shows example structures of data objects that may be included in a particular courseware delivery. Employment of networking may permit the subsystems 104, 105, 106, 107, 108, 112 of the SISD system 100 to retrieve assets from third-party asset sources 140, thereby enhancing the timeliness and completeness of data used by the system 100. Although the embodiment of the invention discussed herein describes the simulation asset creation, modification, and adornment functionality performed by the subsystems 104, 105, 106, 107, 108, 112 of the SISD system 100 as illustrated in FIG. 1, those skilled in the art will readily appreciate that stored computer instructions may be configured in any way while still accomplishing the many goals, features and advantages according to the present invention.

Continuing to refer to FIG. 2, for example, and without limitation, the data structure for a three-dimensional (3D) model 241 will now be discussed. A 3D model may be defined as graphics that use a three-dimensional representation of geometric data (often Cartesian) that is stored in a computer. 3D models may comprise avatars (e.g., objects representing the user and other characters), scenes (e.g., virtual world backgrounds), and props (e.g., tangible objects with which characters in the virtual world may interact). For example, and without limitation, props may include vehicles and weapons.

Continuing to refer to FIG. 2, for example, and without limitation, the data structure for an animation 242 will now be discussed. An animation may be defined as a representation of movement created by displaying a series of pictures displayed in such a way as to form an illusion of continuous motion. Figures represented as 2D or 3D models may be animated to represent movement to a view of a computer monitor. For example, and without limitation, typical figure movements may include body movements, eye movements, and bipedal locomotion.

Continuing to refer to FIG. 2, for example, and without limitation, the data structure for an audio asset 243 will now be discussed. Audio, otherwise known as aural display, may be defined as production of sound signals at human-audible frequencies. For example, and without limitation, audio that may be useful for realistic simulation may include ambient sounds, music, sound FX, and spoken language.

Continuing to refer to FIG. 2, for example, and without limitation, the data structures for an environment 244 and effects 245 will now be discussed. An environment may be defined as a backdrop in a virtual world design to approximate an experience the user might undergo in the actual environment being simulated. Similarly, use of graphic effects may augment the user experience in the virtual world. For example, and without limitation, simulated environments may include terrains, textures, manmade worlds, natural worlds, and science fiction worlds. Also for example, and without limitation, effects may include colors, shading, shapes, and textual content.

Those skilled in the art will appreciate that the present invention contemplates the use of data structures that may store information supporting any or all of the operations involved in delivering gaming and simulation services. The disclosure of the exemplary data structures above is not meant to be limiting in any way. Those skilled in the art will readily appreciate that data structures may include any number of additional or alternative data sources, and may be configured in any way while still accomplishing the many goals, features and advantages according to the present invention.

UNITY® is not designed to support a robust courseware development discipline. More specifically, UNITY® is not based on a training construct, but instead is configured for use by media technicians concerned with creation of gaming and simulation assets. Consequently, creating courseware that uses UNITY® assets suffers from the problems described above related to stovepiping. For example, subject matter experts may use a first set of systems and/or methods to capture training requirements and communicate those to an ISD. The ISD, in turn, may use a second set of systems and/or methods to structure a lesson to be automated. The ISD may then collaborate with a media technician (who may employ yet a third set of systems and/or methods) to create a gaming/simulation prototype to demonstrate understanding of the requirements communicated through subject matter experts. More specifically, the ISD may provide guidance to a UNITY® media technician who may perform software programming to create the requisite asset. Such stovepiping requires engagement of a highly-paid and skilled media technician each time a simulation asset is created or modified, which is inefficient and a direct contributor to the high cost of courseware development.

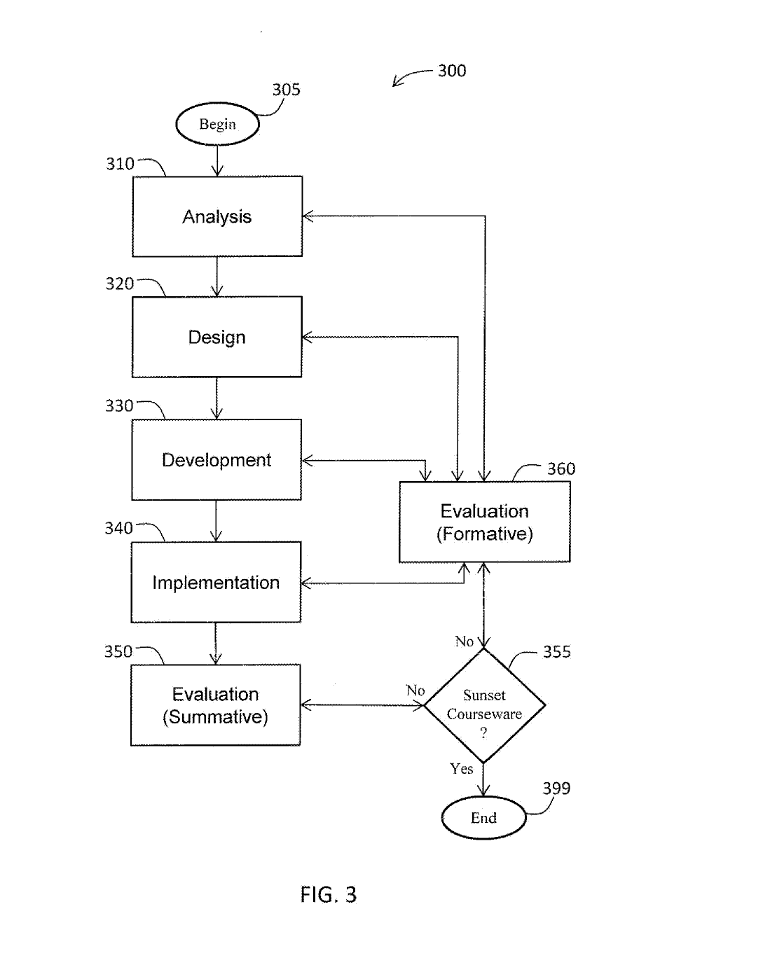

To address this limitation, the SISD system 100, according to embodiments of the present invention, may include a series of tools that support an instruction system design discipline that advantageously includes gaming and simulation assets created using the UNITY® application. Referring now to FIG. 3, and continuing to refer to FIG. 1, the process 300 of creating and maintaining courseware that includes gaming and simulation assets is discussed in greater detail. The field of Instructional Systems Design (ISD) typically involves the application of proven systematic processes to develop education and training programs in a consistent and reliable fashion. For example, and without limitation, a widely practiced process for development of computer-assisted training is the Analysis, Design, Development, Implementation, and Evaluation (ADDIE) model.

As illustrated in FIG. 3, and from the beginning at Block 305, the Analysis Subsystem 104 may execute an analysis step (Block 310). For example, and without limitation, the analysis step (Block 310) may include a needs assessment to identify a training goal and related learning objectives. At Block 320, the Design Subsystem 105 may execute a design step. For example, and without limitation, the design step (Block 320) may involve preparation of course activities and media (for example, audio and/or video environments) needed to deliver desired instruction in satisfaction of the learning objectives. In the development (Block 330) and implementation (Block 340) steps, which may be executed by the Development Subsystem 106 and Implementation Subsystem 107, respectively, specific automated tools for delivery of the desired training may be created and deployed. The Evaluation Subsystem 108 may perform an evaluation of the degree to which learning objectives are met using the computer-implemented instructional system. Such training assessment may involve both formative assessments at Block 360 (performed, for example and without limitation, during analysis, design, and/or development) and summative assessments at Block 350 (performed, for example and without limitation, during implementation and/or post-delivery). Such evaluation results may advantageously be used to catalyze modifications to improve the system. At Block 355, a determination regarding the lifespan of the subject courseware may be made. If a decision not to drive the courseware to end of life (also called “sunset”) is received by the system 100, then evaluation feedback may spawn continuous improvement of the courseware by repeating some or all of the analysis 310, design 320, development 330, implementation 340, and evaluation 350, 360 steps. If a decision to sunset the courseware application is received by the system 100, then the process may end at Block 399.

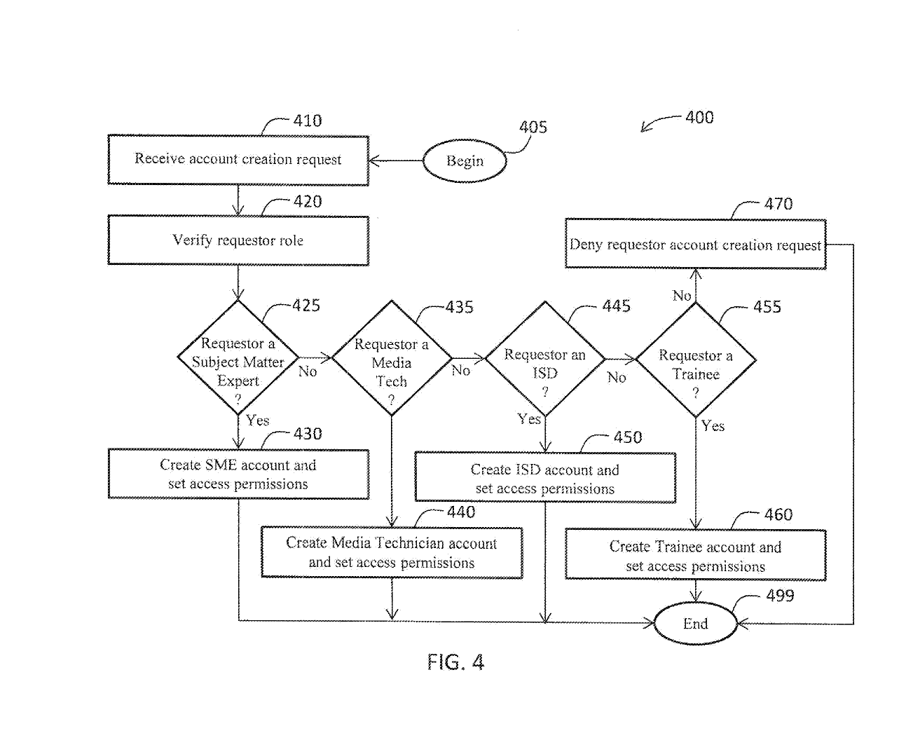

Referring now to FIG. 4, and continuing to refer to FIG. 1, the Access Control Subsystem 112, according to an embodiment of the present invention, will now be discussed. For example, and without limitation, the Access Control Subsystem 112 may be configured to facilitate role-based access control (e.g., user registration and association with permissions based on a user's role in the courseware creation and use processes). From the start (Block 405), the access control system 112 may receive a request to create a user account to access the SISD system 100 (Block 410). For example, and without limitation, setup of an approved account may include association of the account with a logon and password combination. At Block 420, the account control subsystem 112 may process identifying information for the user to verify the user's role in the courseware creation process. The user's role may be determined to be that of a Subject Matter Expert (Block 425), a Media Technician (Block 435), an Instructional System Designer (Block 445), or a Trainee (Block 455), and the user's access permissions within the SISD system 100 may be set accordingly (Blocks 430, 440, 450, or 460, respectively) before the process may end at Block 499. For example, and without limitation, association of appropriately-privileged users to specific courseware projects for either creation or use purposes may be based upon the users' recognized roles. Alternatively, if the user's role is not recognized as an approved role within the system 100, then the Access Control Subsystem 112 may deny the user's account creation request (Block 470) before the process may end (Block 499).

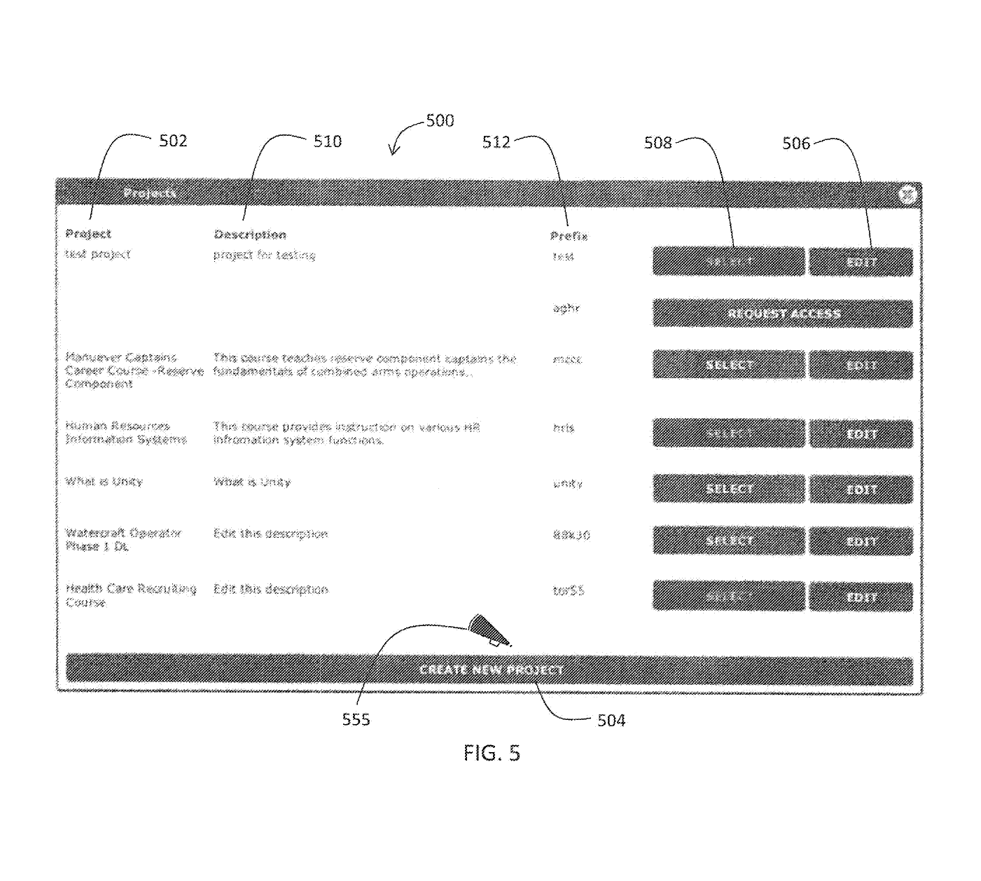

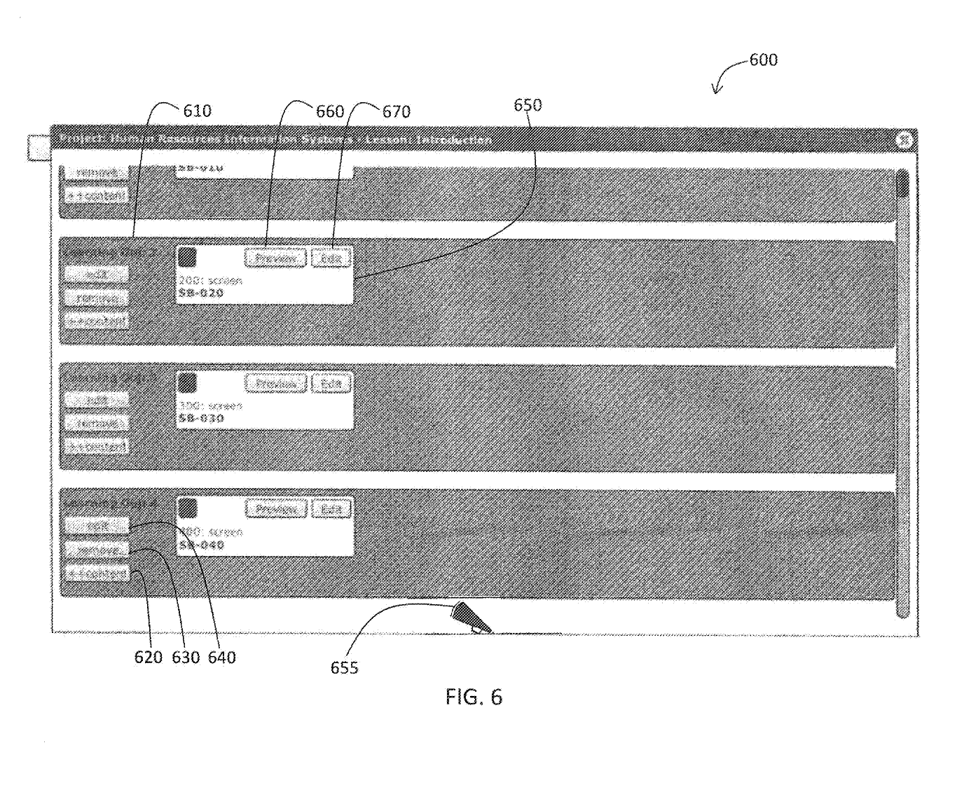

Referring now to FIGS. 5 and 6, and continuing to refer to FIG. 1, the Analysis Subsystem 104, according to an embodiment of the present invention, will now be discussed. The Analysis Subsystem 104 may operate to capture training requirements to be satisfied and learning objectives to be achieved using a particular courseware deliverable. As illustrated in FIG. 5, the SISD system 100 may present to the user a first analysis system interface 500 that may be configured to allow a user to interact with the Analysis Subsystem 104 to organize courseware deliverables into projects 502. For example, and without limitation, the first analysis system interface 500 may present to the user the choices of creating a new project 504, editing or deleting an existing project 506, and selecting an existing project for multi-project manipulation 508. Identifying and indexing information recorded for each project may include a short description 510 and an identifying prefix 512.

As illustrated in FIG. 6, each project may be organized into a set of learning objectives defined for that project. More specifically, the SISD system 100 may present to the user a second analysis system interface 600 that may be configured to allow the user to interact with the Analysis Subsystem 104 to define a set of learning objectives 610 for each project 502. For example, and without limitation, the second analysis system interface 600 may present to the user the choices of creating content for a learning objective record 620, removing the learning objective record 630, or editing an existing learning objective record 640. Creation of a learning objective record 620 may entail association of that record with a particular screen 650 comprising a particular courseware deliverable. For example, and without limitation, the second analysis system interface 600 may present to the user the choices of previewing a created screen 660 and editing an existing screen 670.

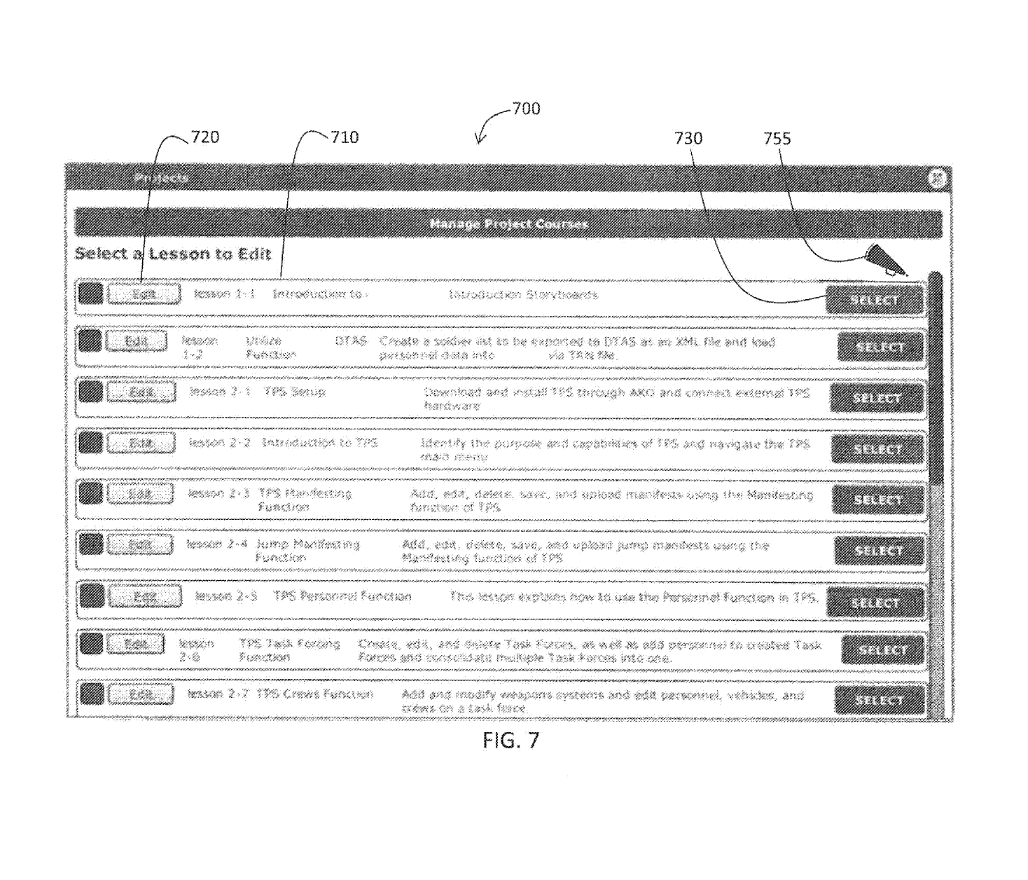

Referring now to FIG. 7, and continuing to refer to FIG. 1, the Design Subsystem 105, according to an embodiment of the present invention, will now be discussed. The Design Subsystem 105 may operate to structure a series of lessons 710 that may be included in a high-level lesson plan for a courseware deliverable and that may be designed to accomplish the learning objectives for a project. For example, and without limitation, a design system interface 700 may present to the user the choices of editing or deleting an existing lesson 720, and selecting an existing lesson for multi-lesson manipulation 730.

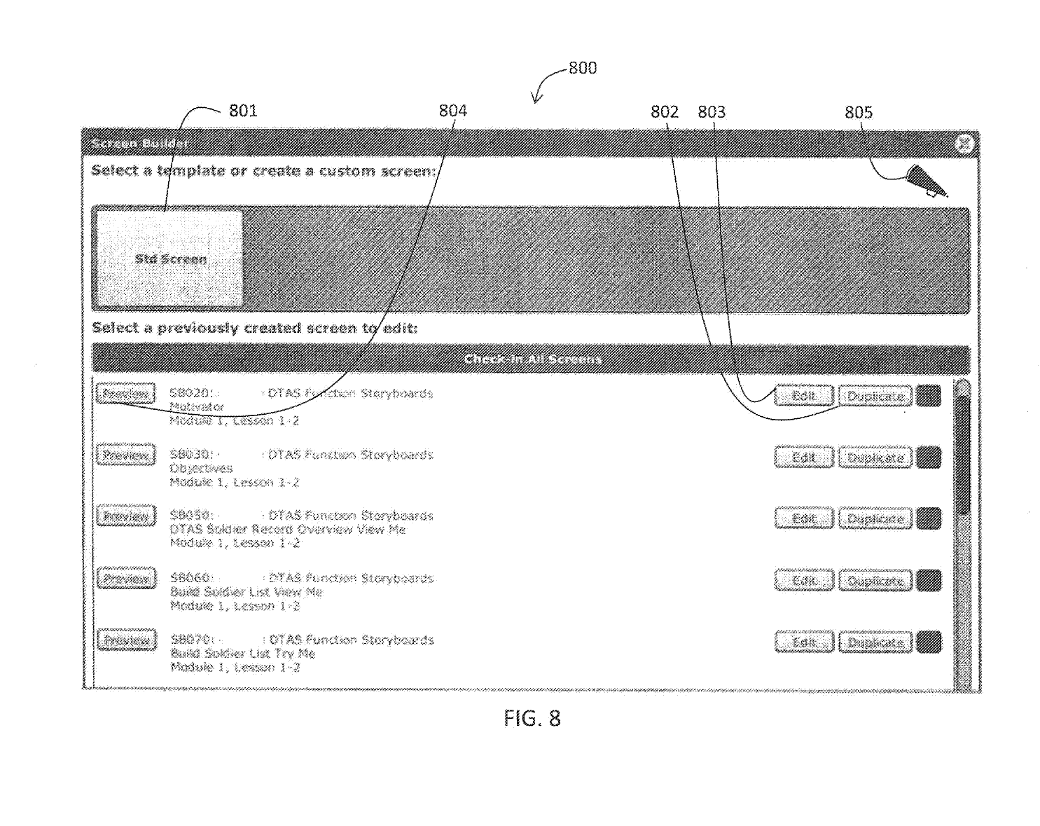

Referring now to FIGS. 8, 9, and 10, and continuing to refer to FIG. 1, the Development Subsystem 106, according to an embodiment of the present invention, will now be discussed. The Development Subsystem 106 may operate to create and maintain the digital content that may be included in a courseware deliverable to enhance the learning experience for the trainee. For example, and without limitation, a first development system interface 800 may present to the user the choices of creating a training presentation screen 801, either from a saved template or as customized by the user. After a screen is created, the first development system interface 800 may be configured to allow the user to edit the existing screen 802, to copy the existing screen for subsequent editing 803, and to preview an existing screen as it may be displayed to a trainee 804.

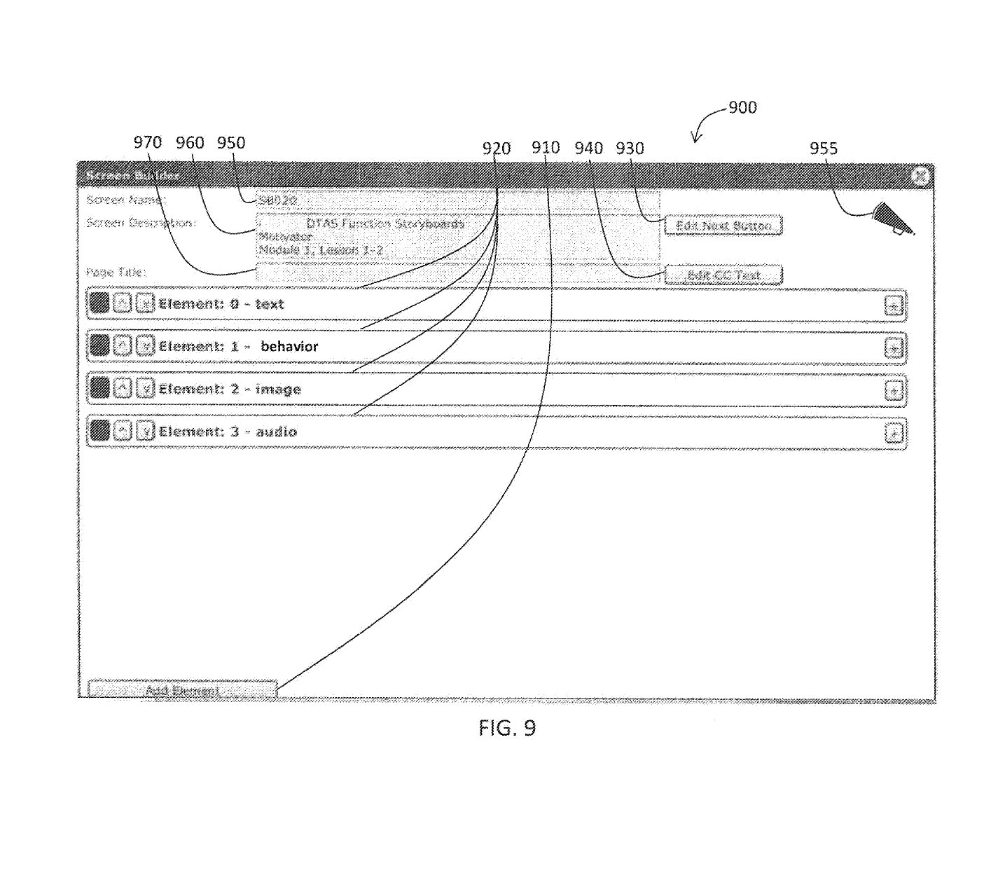

As illustrated in FIG. 9, each screen may be adorned with a set of assets (also known as “elements”) that the SISD system 100 may display to that screen. More specifically, the SISD system 100 may present to the user a second development system interface 900 that may be configured to allow the user to interact with the Development Subsystem 106 to add 910 a set of elements 920 that may be included on a particular screen. The types of elements supported by the SISD system 100 may include, but are not limited to, the asset types described in FIG. 2. For example, and without limitation, the second analysis system interface 900 may present to the user element choices 920 that may include textual objects, behavioral objects, image objects, and/or audio objects. Other element types that may be supported by the SISD system 100 may include videos, multi-media objects, camera angles, avatars, and environments. After elements are created, the user may subsequently modify an element 930, and also may record meta-data describing the element 940.

Continuing to refer to FIG. 9, created elements may be associated to their host screens by screen name 950, by screen description 960, and/or by page title 970. Similarly, the various levels of analysis, design, and development components comprising a courseware deliverable may be represented by the SISD system 100 as a tree structure by recording associations between screens and the lessons those screens implement (as illustrated in FIG. 8), between screens and the lesson objectives those screens satisfy (as illustrated in FIG. 6), and between the lessons and the projects of which those lessons are a part (as illustrated in FIG. 7). For example, and without limitation, such linking and sequencing of courseware components may advantageously facilitate both branching to create new courseware deliverables, and also remediation of shortcomings that may be identified in existing courseware deliverables.

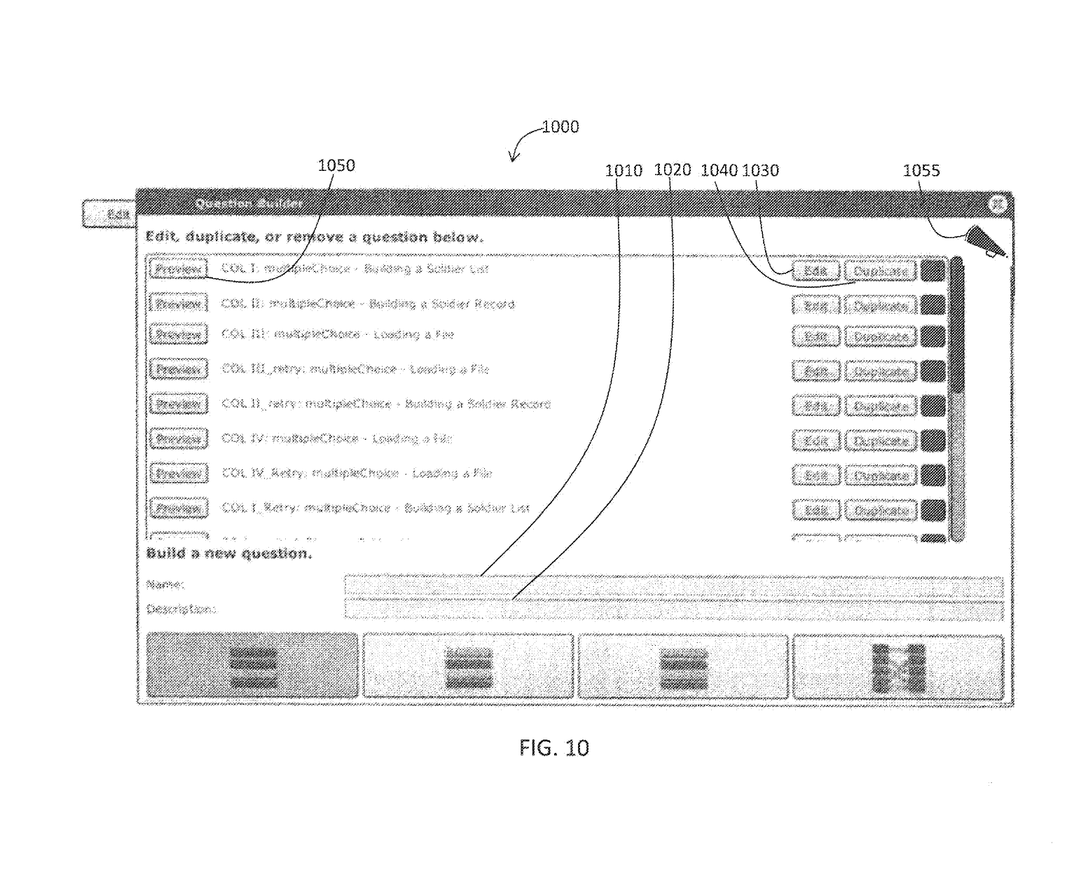

As illustrated in FIG. 10, digital content that may be included in a courseware deliverable may include planned checks on learning. For example, and without limitation, the SISD system 100 may present to the user a third development system interface 1000 that may be configured to allow the user to interact with the Development Subsystem 106 to define a set of questions that may be presented to a trainee to measure the effectiveness of a particular automated lesson. The third Development Subsystem interface 1000 may present to the user options to build a new question that may be identified by name 1010 and/or by description 1020. The third Development Subsystem interface 1000 also may present to the user options to edit an existing question 1030, to copy an existing question for subsequent editing 1040, and/or to preview an existing question as it may be displayed to a trainee 1050.

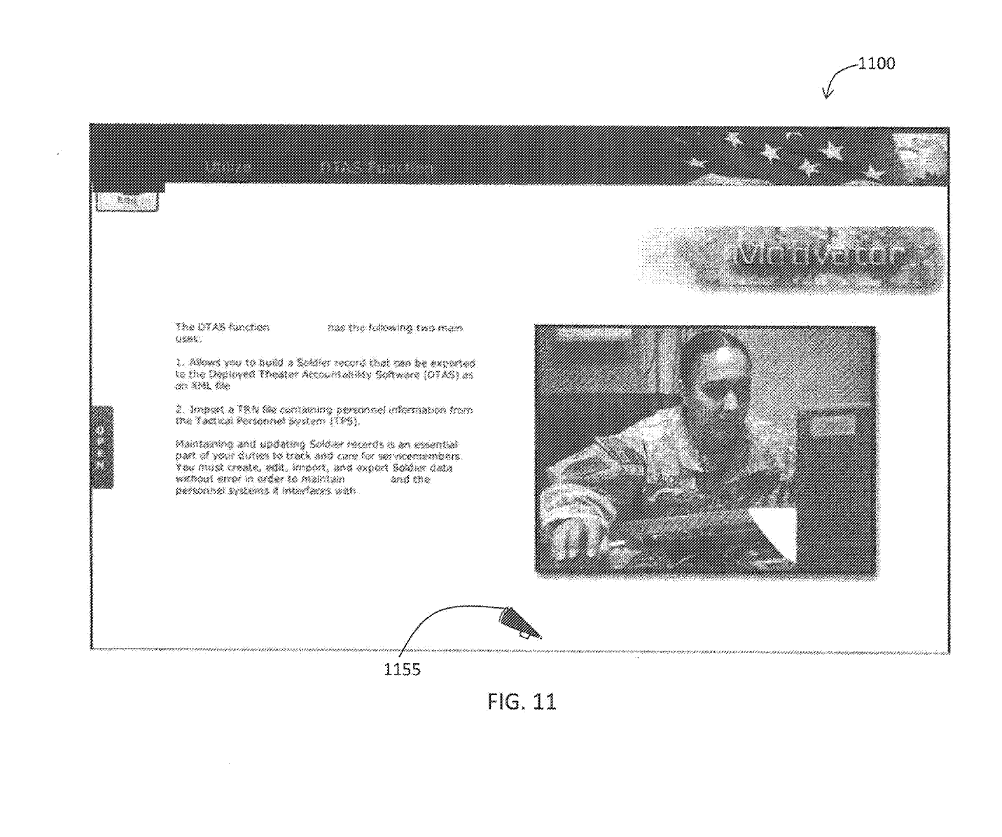

Referring now to FIG. 11, and continuing to refer to FIG. 1, the Implementation Subsystem 107, according to an embodiment of the present invention, will now be discussed. The Implementation Subsystem 107 may operate to display a courseware deliverable in a runtime environment for an appropriately-privileged user. For example, and without limitation, an Implementation Subsystem interface 1100 may display to the user the screens, assets, questions, and any other elements developed during the implementation phase of the ADDIE process, as described above. Also for example, and without limitation, gaming and simulation assets created using the UNITY® development environment may present the user with an interactive virtual world for purposes of enhancing the learning experience. The SISD system 100 may be configured to allow an instructional system designer to preview the virtual world in a runtime environment on a training developer client 110. After the instructional system designer approves the finished-product courseware, perhaps with input from a subject matter expert, the SISD system 100 may be configured to deliver the virtual world in a runtime environment to a trainee client 120, 122, 124 for use by a targeted trainee.

Continuing to refer to FIG. 1, the Evaluation Subsystem 108, according to an embodiment of the present invention, will now be discussed. The Evaluation Subsystem 108 may operate to capture summative and/or formative assessments of the degree to which a courseware deliverable satisfies training requirements and learning objectives. For example, and without limitation, questions developed using the Development Subsystem 106 and displayed using the Implementation Subsystem 107 may elicit answers from trainees to summative evaluation inquiries that may provide insight into the efficiency and effectiveness of the courseware deliverable. Also for example, and without limitation, one or more of the system interfaces 500, 600, 700, 800, 900, 1000, 1100 may include a free-form feedback operator 555, 655, 755, 805, 955, 1055, 1155. A user may use the feedback operator to capture formative evaluation input in the form of comments regarding content associated with the screen that hosts that operator. As illustrated in FIG. 3, summative evaluation results (Block 350) and/or formative evaluation results (Block 360) may be routed back to earlier steps in the closed-loop ADDIE process for further analysis (Block 310), redesign (Block 320), maintenance (Block 330), and redeployment (Block 340) of the courseware. Such capability may facilitate online review of course materials as well as assignment and tracking of reviewer comments

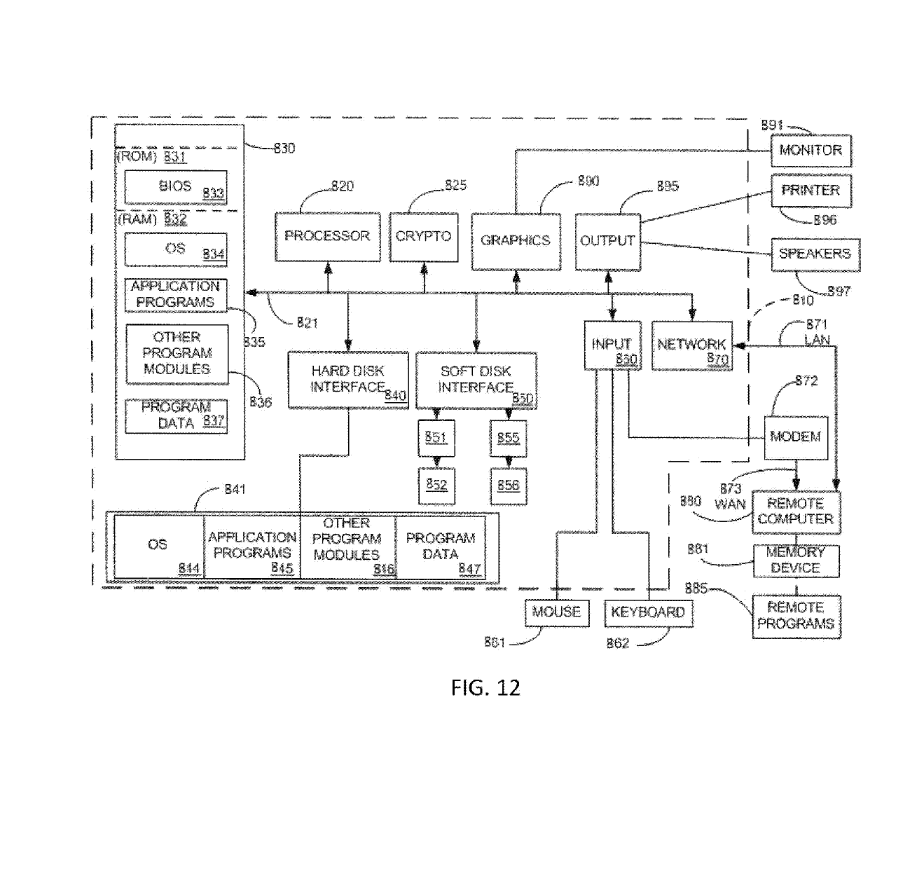

A skilled artisan will note that one or more of the aspects of the present invention may be performed on a computing device. The skilled artisan will also note that a computing device may be understood to be any device having a processor, memory unit, input, and output. This may include, but is not intended to be limited to, cellular phones, smart phones, tablet computers, laptop computers, desktop computers, personal digital assistants, etc. FIG. 12 illustrates a model computing device in the form of a computer 810, which is capable of performing one or more computer-implemented steps in practicing the method aspects of the present invention. Components of the computer 810 may include, but are not limited to, a processing unit 820, a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI).

The computer 810 may also include a cryptographic unit 825. Briefly, the cryptographic unit 825 has a calculation function that may be used to verify digital signatures, calculate hashes, digitally sign hash values, and encrypt or decrypt data. The cryptographic unit 825 may also have a protected memory for storing keys and other secret data. In other embodiments, the functions of the cryptographic unit may be instantiated in software and run via the operating system.

A computer 810 typically includes a variety of computer readable media. Computer readable media can be any available media that can be accessed by a computer 810 and includes both volatile and nonvolatile media, removable and non-removable media. By way of example, and not limitation, computer readable media may include computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by a computer 810. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 12 illustrates an operating system (OS) 834, application programs 835, other program modules 836, and program data 837.

The computer 810 may also include other removable/non-removable, volatile/nonvolatile computer storage media. By way of example only, FIG. 12 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

The drives, and their associated computer storage media discussed above and illustrated in FIG. 12, provide storage of computer readable instructions, data structures, program modules and other data for the computer 810. In FIG. 12, for example, hard disk drive 841 is illustrated as storing an OS 844, application programs 845, other program modules 846, and program data 847. Note that these components can either be the same as or different from OS 833, application programs 833, other program modules 836, and program data 837. The OS 844, application programs 845, other program modules 846, and program data 847 are given different numbers here to illustrate that, at a minimum, they may be different copies. A user may enter commands and information into the computer 810 through input devices such as a keyboard 862 and cursor control device 861, commonly referred to as a mouse, trackball or touch pad. Other input devices (not shown) may include a microphone, joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A monitor 891 or other type of display device is also connected to the system bus 821 via an interface, such as a graphics controller 890. In addition to the monitor, computers may also include other peripheral output devices such as speakers 897 and printer 896, which may be connected through an output peripheral interface 895.

The computer 810 may operate in a networked environment using logical connections to one or more remote computers, such as a remote computer 880. The remote computer 880 may be a personal computer, a server, a router, a network PC, a peer device or other common network node, and typically includes many or all of the elements described above relative to the computer 810, although only a memory storage device 881 has been illustrated in FIG. 12. The logical connections depicted in FIG. 12 include a local area network (LAN) 871 and a wide area network (WAN) 873, but may also include other networks 140. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 12 illustrates remote application programs 885 as residing on memory device 881.

The communications connections 870 and 872 allow the device to communicate with other devices. The communications connections 870 and 872 are an example of communication media. The communication media typically embodies computer readable instructions, data structures, program modules or other data in a modulated data signal such as a carrier wave or other transport mechanism and includes any information delivery media. A “modulated data signal” may be a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Computer readable media may include both storage media and communication media.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

Many modifications and other embodiments of the invention will come to the mind of one skilled in the art having the benefit of the teachings presented in the foregoing descriptions and the associated drawings. The scope of the invention should be determined by the appended claims and their legal equivalents, and not by the examples given Therefore, it is understood that the invention is not to be limited to the specific embodiments disclosed.

That which is claimed is:

1. A computer program product embodied in a non-transitory computer-readable storage medium for generating executable code for a simulation-based courseware program comprising:
a courseware server comprising a processor, a database, a compiler, and a plurality of subsystems including an analysis subsystem, a design subsystem, a development subsystem, and an implementation subsystem;
wherein each of the plurality of subsystems comprises a respective interface to manipulate information included in the database;
wherein the analysis subsystem is configured to receive a project definition and a training objective;
wherein the design subsystem is configured to receive an instructional strategy, a course activity, and a course content;
wherein the development subsystem is configured to receive a plurality of assets, at least one of which is a simulation asset;
wherein the database is configured to store the project definition, the training objective, the instructional strategy, the course activity, the course content, and the plurality of assets to the information included in the database; and
wherein the implementation subsystem is configured to generate the simulation-based courseware program using the information in the database.

2. The computer program product according to claim 1 wherein the plurality of assets further comprises at least one of a text asset, an image asset, an audio asset, and a video asset.

3. The computer program product according to claim 1 wherein the implementation subsystem is configured to operate the compiler to create the executable computer code for the simulation-based courseware program.

4. The computer program product according to claim 1 wherein the plurality of subsystems further includes an access control subsystem comprising an interface to manipulate the information included in the database; wherein the access control subsystem is configured to
receive a computer program product access request, and
match the computer program product access request to a training developer registration stored in the database, and
operate at least one of the plurality of subsystems to include enforcing role-based permissions associated with the trainer registration and selected from the group consisting of a subject matter expert role, an information system designer role, and a media technician role.

5. The computer program product according to claim 1 further comprising a training developer client configured in data communication with the courseware server via a network; wherein the training developer client is further configured to create and transmit to the courseware server at least one of the project definition, the training objective, the instructional strategy, the course activity, the course content, and the plurality of assets.

6. The computer program product according to claim 1 wherein the access control subsystem is further configured to receive a courseware program access request, to match the courseware program access request to a trainee registration stored in the database, and to enforce role-based permissions associated with the trainee registration and selected from the group consisting of a trainee role.

7. The computer program product according to claim 1 further comprising a trainee client configured in data communication with the courseware server via a network; wherein the trainee client is configured to operate the simulation-based courseware program to display the simulation asset, to receive trainee input, and to manipulate a behavior of the simulated asset based on the trainee input.

8. The computer program product according to claim 7 wherein the simulation asset is of an asset type selected from the group consisting of an avatar, a scene, and a prop.

9. The computer program product according to claim 7 wherein the behavior of the simulation asset is of a behavior type selected from the group consisting of a movement, a sound, and an environment.

10. The computer program product according to claim 1 wherein the plurality of subsystems further includes an evaluation subsystem configured to receive an indicator of training completion.

11. The computer program product according to claim 10 wherein the evaluation subsystem is further configured to execute at least one of a pre-test evaluation and a post-test evaluation.

12. A method for generating executable computer code for a simulation-based courseware program using a computer program product that includes a courseware server comprising a processor, a database, a compiler, and a plurality of subsystems including an analysis subsystem, a design subsystem, a development subsystem, and an implementation subsystem, wherein each of the plurality of subsystems comprises a respective interface to manipulate information included in the database, the method comprising:
receiving, using the analysis subsystem, a project definition and a training objective;
receiving, using the design subsystem, an instructional strategy, a course activity, and a course content;
receiving, using the development subsystem, a plurality of assets, at least one of which is a simulation asset;
operating the database to store the project definition, the training objective, the instructional strategy, the course activity, the course content, and the plurality of assets to the information included in the database; and
generating, using the implementation subsystem, the simulation-based courseware program using the information in the database.

13. The method according to claim 12 wherein the plurality of assets further comprises at least one of a text asset, an image asset, an audio asset, and a video asset.

14. The method according to claim 12 wherein generating the simulation-based courseware program further comprises creating, using the compiler, the executable computer code for the simulation-based courseware program.

15. The method according to claim 12 wherein the plurality of subsystems further includes an access control subsystem comprising an interface to manipulate the information included in the database; and the method further comprising:
receiving, using the access control subsystem, a computer program product access request,
matching, using the access control subsystem, the computer program product access request to a training developer registration stored in the database, and
operating at least one of the plurality of subsystems to include
enforcing, using the access control subsystem, role-based permissions associated with the trainer registration and selected from the group consisting of a subject matter expert role, an information system designer role, and a media technician role.

16. The method according to claim 12 wherein the computer program product further comprises a training developer client configured in data communication with the courseware server via a network; the method further comprising:
creating and transmitting to the courseware server, using the training developer client, at least one of the project definition, the training objective, the instructional strategy, the course activity, the course content, and the plurality of assets.

17. The method according to claim 12 further comprising:
receiving, using the access control subsystem, a courseware program access request,
matching, using the access control subsystem, the courseware program access request to a trainee registration stored in the database, and
enforcing, using the access control subsystem, role-based permissions associated with the trainee registration and selected from the group consisting of a trainee role.

18. The method according to claim 12 wherein the computer program product further comprises a trainee client configured in data communication with the courseware server via a network; and the method further comprising:
operating the simulation-based courseware program using the trainee client to display the simulation asset, to receive trainee input, and to manipulate a behavior of the simulated asset based on the trainee input.

19. The method according to claim 18 wherein the simulation asset is of an asset type selected from the group consisting of an avatar, a scene, and a prop.

20. The method according to claim 18 wherein the behavior of the simulation asset is of a behavior type selected from the group consisting of a movement, a sound, and an environment.

21. The method according to claim 12 wherein the plurality of subsystems further includes an evaluation subsystem; and the method further comprising:
receiving, using the evaluation subsystem, an indicator of training completion.

22. The method according to claim 21 wherein receiving the indicator of training completion further comprises performing at least one of a pre-test evaluation and a post-test evaluation.

23. A method for generating executable computer code using a computer program product that includes a courseware server comprising a processor, a database, and a compiler, the method comprising:
receiving a project definition and a training objective;
receiving an instructional strategy, a course activity, and a course content;
receiving a plurality of assets, at least one of which is a simulation asset;
operating the database to store the project definition, the training objective, the instructional strategy, the course activity, the course content, and the plurality of assets to information to be included in the database; and
generating a simulation-based courseware program using the information in the database.

24. The method according to claim 23 wherein the plurality of assets further comprises at least one of a text asset, an image asset, an audio asset, and a video asset; wherein generating the simulation-based courseware program further comprises creating the executable computer code for the simulation-based courseware program.

25. The method according to claim 23 further comprising:
receiving a computer program product access request,
matching the computer program product access request to a training developer registration stored in the database, and
operating at least one of the plurality of subsystems to include
enforcing role-based permissions associated with the trainer registration and selected from the group consisting of a subject matter expert role, an information system designer role, and a media technician role.

26. The method according to claim 23 further comprising creating and transmitting at least one of the project definition, the training objective, the instructional strategy, the course activity, the course content, and the plurality of assets.

27. The method according to claim 23 further comprising:
receiving a courseware program access request,
matching the courseware program access request to a trainee registration stored in the database, and
enforcing role-based permissions associated with the trainee registration and selected from the group consisting of a trainee role.

28. The method according to claim 23 further comprising operating the simulation-based courseware program to display the simulation asset, to receive trainee input, and to manipulate a behavior of the simulated asset based on the trainee input; wherein the simulation asset is of an asset type selected from the group consisting of an avatar, a scene, and a prop; and wherein the behavior of the simulation asset is of a behavior type selected from the group consisting of a movement, a sound, and an environment.

29. The method according to claim 12 further comprising receiving an indicator of training completion; wherein receiving the indicator of training completion further comprises performing at least one of a pre-test evaluation and a post-test evaluation.
